(19) United States
(12) Patent Application Publication
(10) Pub. No.: US 2009/0294528 A1
(43) Pub. Date: Dec. 3, 2009

(54) STORED-VALUE CARD WITH EMBOSSED INDICIA

(75) Inventors: Ted C. HALBUR, Lino Lakes, MN (US); Shawn P. BOYD, St. Paul, MN (US)

Correspondence Address: TARGET BRANDS, INC., 1000 NICOLLET MALL, TPS-3165, MINNEAPOLIS, MN, 55403, US

(73) Assignee: TARGET BRANDS, INC., Minneapolis, MN (US)

(21) Appl. No.: 12/130,112

(22) Filed: May 30, 2008

(51) Int. Cl. G06F 7/08; G06K 19/06

(52) U.S. Cl. 235/381; 235/490

(57) ABSTRACT

A transaction card includes a substrate having embossed indicia configured, for example, to emulate a license plate. The substrate defines a first surface and a second surface, wherein the first surface is opposite the first surface. The substrate includes embossed indicia defined by regions projecting in relief with respect to the first surface and/or the second surface. The embossed indicia may, for example, emulate a license plate or the like. The substrate further includes an account identifier linking the transaction card to at least one of an account and a record. Stored-value cards, methods of providing a stored-value card, and other embodiments of stored-value or transaction cards and associated combinations are also disclosed.

### BACKGROUND OF THE INVENTION

Stored-value cards and other transaction cards come in many forms. A gift card, for example, is a type of stored-value card that includes a pre-loaded or selectively loaded monetary value. In one example, a consumer buys a gift card having a specified value for presentation as a gift to another person. In another example, a consumer is offered a gift card as an incentive to make a purchase. A gift card, like other stored-value cards, can be “recharged” or “reloaded” at the direction of the bearer. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. Gift cards and other stored-value cards provide a number of advantages to both the consumer and the retailer.

### SUMMARY OF THE INVENTION

One aspect of the present invention relates to a transaction card including a substrate having embossed indicia and configured, for example, to emulate a license plate. The substrate defines a first surface and a second surface, wherein the first surface is opposite the first surface. The substrate includes embossed indicia defined by regions projecting in relief with respect to the first surface and/or the second surface. The embossed indicia may, for example, emulate a license plate or the like. The substrate further includes an account identifier linking the transaction card to at least one of an account and a record. Stored-value cards, methods of providing a stored-value card, and other embodiments of stored-value or transaction cards and associated combinations are also disclosed.

### BRIEF DESCRIPTION OF THE DRAWINGS

Embodiments of the invention will be described with respect to the figures, in which like reference numerals denote like elements, and in which:

FIG. 1 is a perspective view illustration of a stored-value card with embossed indicia, according to one embodiment of the present invention.

FIG. 2 is a front view illustration of the stored-value card of FIG. 1.

FIG. 3 is a rear view illustration of the stored-value card of FIG. 1.

FIG. 4 is a right side view illustration of the stored-value card of FIG. 1.

FIG. 5 is a left side view illustration of the stored-value card of FIG. 1.

FIG. 6 is a top view illustration of the stored-value card of FIG. 1.

FIG. 7 is a bottom side view illustration of the stored-value card of FIG. 1.

FIG. 8 is a cross-sectional view illustration taken along the line 8-8 in FIG. 2, according to one embodiment of the invention.

FIG. 9 is a flow chart illustrating a method of forming the stored-value card of FIG. 1, according to one embodiment of the invention.

FIG. 10 is a front view illustration of a backer, according to one embodiment of the present invention.

FIG. 11 is a rear view illustration of a stored-value card assembly including the backer of FIG. 12 and the stored-value card of FIG. 1, according to one embodiment of the present invention.

FIG. 12 is a flow chart illustrating a method of encouraging purchase and facilitating use of a stored-value card, according to one embodiment the present invention.

FIG. 13 is a flow chart illustrating a method of using a stored-value card, according to one embodiment of the present invention.

### DETAILED DESCRIPTION

The following detailed description of the invention merely provides examples and is not intended to limit the invention or the application and uses of the invention. Furthermore, there is no intention to be bound by any theory presented in the preceding background of the invention or the following detailed description of the invention.

A stored-value card or transaction product, such as a gift card, is adapted for making purchases of goods and/or services at, for example, a retail store or web site. According to one embodiment, an original consumer buys a stored-value card to give a recipient who in turn is able to use it to pay for goods and/or services. A stored-value card, according to various embodiments of the present invention, includes embossed indicia projecting in relief from one or more of its surfaces. A significant portion of the total card area may thus be embossed, allowing the card to emulate a license plate or other such item.

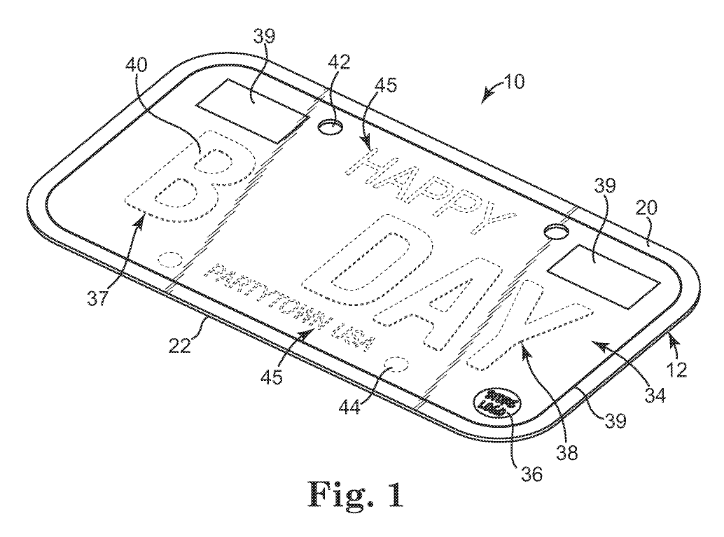

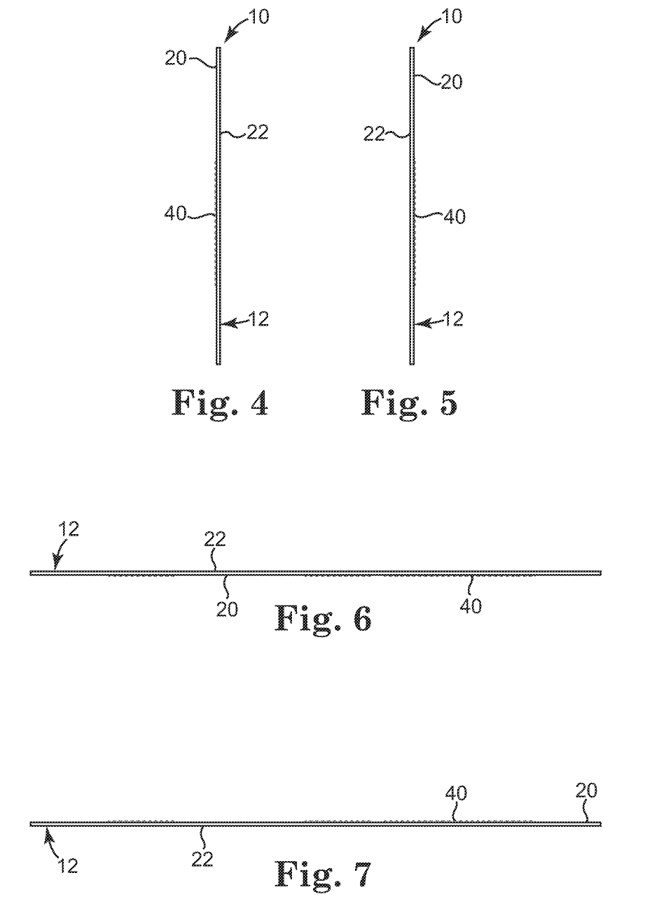

Turning to the figures, FIGS. 1-7 illustrate various views of one embodiment of a financial or stored-value product or card 10 including a substrate 12 that includes embossed indicia 38, which are defined by regions 40 projecting in relief with respect to surface 20 and/or opposite surface 22. Substrate 12 is any suitable material such as a somewhat rigid yet flexible material similar to that commonly used for identification cards, credit cards, etc. More specifically, in one embodiment, substrate 12 is a substantially planar member formed of paper, cardstock, plastic (e.g., polycarbonate, polystyrene, polyvinyl chloride (PVC), acrylonitrile butadiene styrene (ABS), polyethylene terephthalate (PET), teslin, polyactide (PLA), and acrylic), or other suitable material. In one embodiment, substrate 12 is formed of injection molded plastic or cut from sheet-stock plastic material. Substrate 12 can be formed in any other suitable planar or non-planar configuration as will be apparent to those of skill in the art upon reading this application.

In one embodiment, substrate 12 defines a first surface 20 (i.e., a first major surface) and a second surface 22 (i.e., a second major surface) opposite first surface 20 separated by a thickness of stored-value card 10. In one embodiment, at least one of first and second surfaces 20 and 22 is substantially planar. In one embodiment, substrate 12 is substantially rectangular in shape, and, in one example, is similarly sized to an identification card, a credit card, or other card sized to fit in a wallet of a card bearer (i.e., is wallet sized). Accordingly, in one example, each of first and second surfaces 20 and 22 are substantially rectangular and/or otherwise wallet sized. In one embodiment, the overall dimensions of substrate 12 are about 8.5 cm by about 5.5 cm wide with a thickness of less than about 1 mm. In other embodiments, substrate 12 is otherwise shaped as a square, circle, oval, star, or any other suitable shape. In one embodiment, substrate 12 is rectangular and is characterized by an aspect ratio similar to that of a vehicle registration plate (or “license plate”) of the type used in connection with automobiles, motorcycles, and other such motor vehicles.

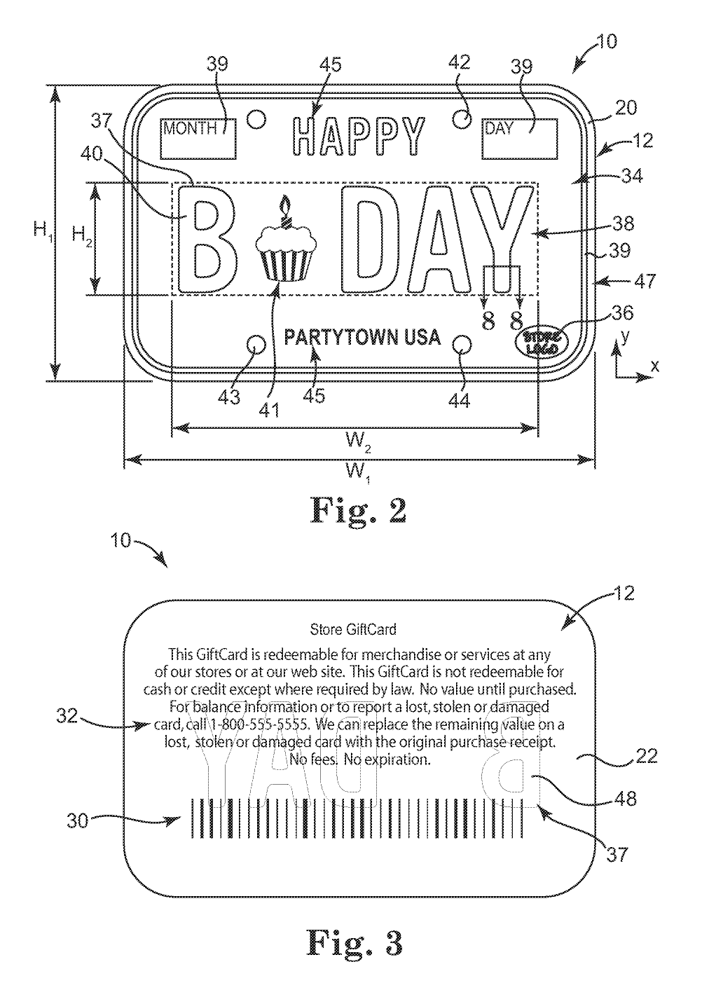

Referring to the rear view illustration of FIG. 3, stored-value card 10, for example, second surface 22 of substrate 12, includes at least one account activation area or account identifier 30, such as a bar code, a magnetic strip, a smart chip or other electronic device, a radio frequency identification (RFID) device, or other suitable identifier readily machine readable by a point-of-sale terminal, account access station, kiosk, or other suitable device. In one embodiment where account identifier 30 is machine readable, account identifier 30 is also readable by a bearer of stored-value card 10 such that stored-value card 10 can be used when a machine configured to read stored-value card 10 is not present (e.g., when using stored-value card 10 to make a purchase on a web site). For example, account identifier 30 may include a number or letter string identifying the associated account or record and/or a password (not illustrated) associated therewith. In one embodiment, account identifier 30 is printed on or otherwise applied to second surface 22 of substrate 12; however, the account identifier 30 could additionally or alternatively be printed or applied to the first surface 20 of substrate 12. As shown, region 48 of embossed indicia 37, which is opposite region 40, is generally visible when viewing surface 22 of stored-value card 10.

Account identifier 30 indicates and therefore links stored-value card 10 to a financial or other stored-value account or record. The account or record indicates a value or balance (e.g., monetary value, points, minutes, or other balance) associated with stored-value card 10 and optionally is maintained on a database, other electronic or manual record-keeping system, or, in the case of “smart” cards for example, on a chip or other electronic device on/in stored-value card 10 itself. Accordingly, by scanning account identifier 30, the account or record linked to stored-value card 10 is identified and can subsequently be activated, have amounts debited therefrom, and/or have amounts credited thereto. Account identifier 30 is one example of means for linking stored-value card 10 with an account or record.

In one embodiment, redemption indicia 32 are included on stored-value card 10 such as on second surface 22 of substrate 12. Redemption indicia 32 indicate that stored-value card 10 is redeemable for the purchase of goods and/or services and that, upon use, a value of the purchased goods and/or services will be deducted from the account or record linked to stored-value card 10. In one embodiment, redemption indicia 32 include phrases such as “<NAME OF STORE> GiftCard” and “This GiftCard is redeemable for merchandise or services at any of our stores or at our web site,” provides help or phone line information in the case of a lost, stolen, or damaged stored-value card, etc.

In one embodiment, stored-value card 10 includes printed indicia 34. Printed indicia 34 include any suitable graphics, text, or combinations thereof. In one example, printed indicia 34 include one or more brand identifiers 36 and/or other graphical items, described in further detail below. Brand identifiers 36 include one or more of a logo, text, trademark, etc. that associate stored-value card 10 with at least one of a product, a brand, a store, etc. In one embodiment, printed indicia 34 and embossed indicia 37 together emulate a license plate, as described in detail below. Other indicia or additional features may also be included on stored-value card 10 as will be apparent to those of skill in the art upon reading this application. Any one or more of printed indicia 34 and brand identifier 36 may not be included on stored-value card 10.

Embossed indicia 37 may include a set of alphanumeric characters 37 associated with a celebratory event. For example, in the illustrated embodiment, alphanumeric characters 37 include the letters “B DAY” generally centered vertically and oriented along the major axis of stored value card 10. At the same time, printed indicia 34 may also include text coinciding with alphanumeric characters 37, thus further accentuating the embossed indicia 38.

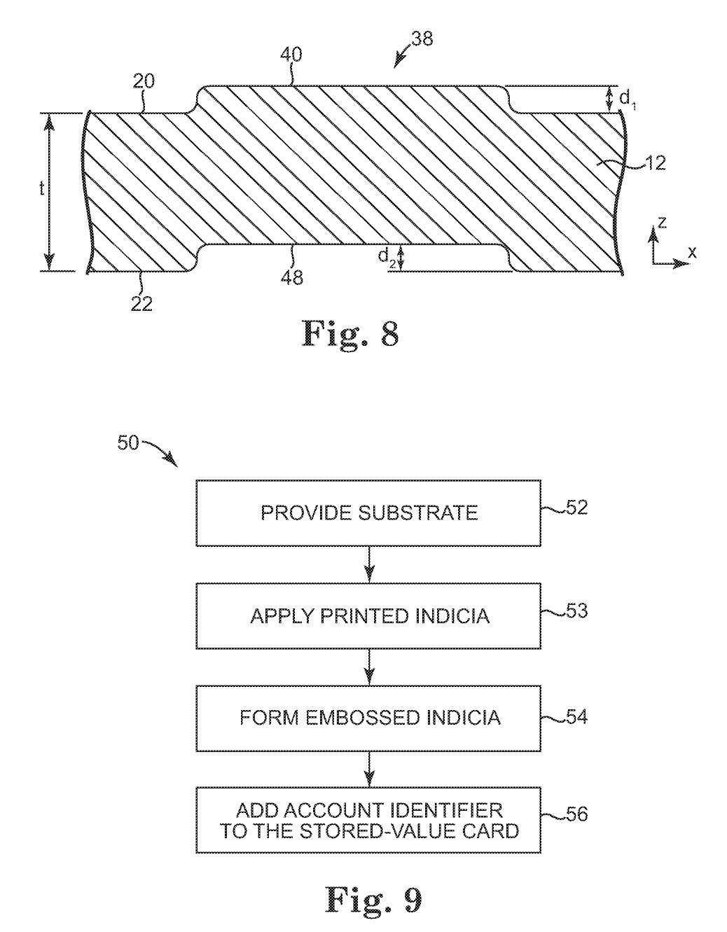

FIG. 8 depicts a cross-sectional view of stored-value card 10 along the line 8-8 in FIG. 2 in accordance with one embodiment of the invention. More particularly, as shown in FIG. 2, section line 8-8 corresponds to the bottom portion of a letter “Y” that forms one of the alphanumeric characters 37 included in embossed indicia 38. With reference to FIG. 8, embossed indicia 38 are defined by region 40, which projects in relief with respect to surface 20, and is also defined by region 48, which projects in relief with respect to surface 22. That is, embossed indicia 38 projects in positive relief (in the positive z-axis direction) with respect to surface 20, and negative relief (in the negative z-axis direction) with respect to surface 22. As is known in the art, positive relief of region 40 is often referred to as “embossing,” while the negative relief of region 48 may be referred to as “debossing.” In the interest of conciseness, the term “embossing” is used herein to refer to any change in height or thickness in a direction orthogonal to the primary plane of stored-value card 10 (e.g., the x-y plane illustrated in FIG. 2).

As shown in FIG. 8, region 48 projects into substrate 12 a distance d₂ relative to surface 22, while region 40 projects out from substrate 12 a distance d₁ relative to surface 20. The values of d₁ and d₂—which may or may not be equal—are selected in accordance with the desired visual effect and the nature of the embossing process used. In one embodiment, for example, d₁ and d₂ are each 25% or less of the total thickness t of substrate 12. In an exemplary stored-value card 10 having a total thickness of approximately 1.0 mm, d₁ and d₂ may be less than or equal to 250 μm. It will be appreciated that substrate 12 need not be embossed with respect to both surfaces 20 and 22. Furthermore, each surface 20 may be embossed in a direction opposite to that illustrated in FIG. 8.

In one embodiment, embossed indicia 38 of stored-value card 10 differ from that of standard embossed credit cards in a number of respects. For example, the embossed font dimensions for standard banking cards are covered by International Standard ISO/IEC 7811-1, which specifies a relatively small, thin character set. Specifically, the maximum character height is given as 4.32 mm, and the centerline-to-centerline spacing is specified as 3.63 mm. In contrast, in one example, embossed indicia 38 of stored-value card 10 include characters that are significantly greater in width in relation to the size of the card. For example, the width of the bottom of the “Y” shown in FIG. 8 is, in one embodiment, greater than 1.0 mm, and in a particular embodiment is approximately 2.0 mm. In contrast, the stroke width of the numbers embossed on a standard credit card is 0.51 mm.

Furthermore, in one embodiment, alphanumeric characters 37 are disposed within an area that covers a significantly greater portion of surface 20 (and/or surface 22). As shown in FIG. 2, region 43 defines the outer perimeter of alphanumeric characters 37, and has a height H₂ (along its major axis) of approximately 18.2 mm, and a width W₂ (along its minor axis) of approximately 63.5 mm. For a standard card size having a width W₁ of approximately 85.0 mm, and a height H₁ of approximately 55.0 mm, the area of region 43 is greater than about 15% of the total area of stored-value card 10, for example, approximately 23-25% of the total area of stored-value card 10. Standard credit cards, in contrast, include an embossed number area that is approximately 70 mm×5 mm, or approximately 7-8% of the total card area. Furthermore, alphanumeric characters 37 may have a character height that is greater than 30%, or approximately ⅓, of the height (or other outer dimension) of stored-value card 10.

Note also that, with respect to standard credit cards, ISO/IEC 7811-1 provides that the embossed character height should be 0.48 mm (i.e., approximately 60% of the card thickness). As described in detail above, the present embodiments allow for a much lower embossing height (d₁ and d₂ in FIG. 8).

As mentioned above, printed indicia 34 and embossed indicia 38 may be together configured to visually emulate a vehicle registration plate or “license plate.” As is known, a license plate is generally a metal or plastic plate configured to be attached to a motor vehicle, trailer, motorcycle, etc. for official identification purposes. Toward this end, license plates, depending upon the country of origin, typically include an alphanumeric code that uniquely identifies the vehicle within the issuing region.

The size and aspect ratio of license plates vary, ranging from the 300 mm×150 mm plates used in the U.S. to the 520 mm×120 mm plates used in the majority of European countries. In addition to an alphanumeric code, license plates may also include graphics, stickers, and other visual elements. These visual elements may have an official purpose or may be chiefly decorative. Many license plates include embossing of the alphanumeric code, while some U.S. states have migrated to substantially flat license plates. Without loss of generality, however, the following discussion will focus on a standard embossed U.S. license plate design.

Referring again to FIG. 2, stored-value card 10 may include holes 42 (which may or may not be circular) extending through the entire thickness of substrate 12. Such holes emulate the corresponding holes typically used to secure a license plate to a vehicle. Stored-value card 10 may also include real, printed, or embossed “faux holes” 44 that emulate similar holes often present at the bottom of a typical license plate. In addition, printed indicia may also include a background 47, which may comprise a solid color or may include a graphic, for example, a graphic associated with a celebratory setting (such as a birthday party) or a graphic used by a particular state on their license plates.

Stored-value card 10 may also include printed or embossed regions 39 that emulate the placement of registration stickers in the upper right and upper left corners of a license plate. In one embodiment, each such region 39 includes printed date indicia (“month” and “date”) that prompts the bearer to write the corresponding birthday information within the indicated area. Toward this end, in one example, surface 20 within regions 39 is textured, coated, or otherwise configured to produce signature panels that accept ink from a standard ball-point pen or marker.

Printed indicia 34 and/or embossed indicia 38 may further include text 45 associated with a celebratory event, such as a birthday. In the illustrated embodiment, such text includes the word “HAPPY” in the area usually reserved for the name of the issuing U.S. state, and the phrase “PARTYTOWN USA” in the area usually reserved for a state motto or other such phrase. Other suitable text 45 will be apparent to those of skill in the art upon reading the present application.

Printed indicia 34 and/or embossed indicia 38 may include a graphic 41 situated before, between, or after the various alphanumeric characters. Graphic 41 thus emulates an accent graphic often included on some U.S. license plates. In the illustrated embodiment, graphic 41 includes a cupcake design bearing a single birthday candle.

One embodiment of a method of forming stored-value card 10 is generally indicated at 50 in FIG. 9 and is described with additional reference to FIGS. 2 and 8. More specifically, at 52, substrate 12 is provided. In one embodiment, substrate 12 is formed of PVC or ABS material and is characterized by an absence of varnish, polish, and/or film lamination to encourage adherence of printed indicia 34. Substrate 12 may be initially provided with account identifier 30 or account identifier 30 can be added before or after printing as will be further described below.

At 53, printed indicia 34, if any, are printed or otherwise applied to substrate 12, more particularly, first surface 20 of substrate 12. For instance, printed indicia 34 may be defined with at least a first color and/or with a pattern, etc. that emulates a license plate. In one example, printed indicia 34 are printed on substrate 12 using an ultra-violet (UV)-curable ink. In such an example, once the ink is applied to substrate 12, the ink is cured by exposing substrate 12 with background indicia 34 to UV light.

At 54, embossed indicia 38 are formed in substrate 12. In one example, an “ambient” embossing process is employed. That is, sheets of stored-value cards 10 are placed in a press that is maintained at standard room temperature (e.g., between about 65° F. and 75° F.), and which includes a pair of opposing embossing plates etched or otherwise formed with the desired pattern for embossed indicia 38. One plate (having a negative relief formed therein) contacts surface 20, and the opposite plate (having a positive relief formed therein) contacts surface 22. Suitable pressure is then applied and released, leaving behind the desired pattern for embossed indicia 38 within substrate 12. In one embodiment, a 100-ton two-stage die is used to emboss and then subsequently cut (or punch) the resulting sheets. Other embossing techniques may also be used, including hot embossing, cold embossing, and other processes known in the art. Furthermore, while embossing (54) is illustrated as occurring after the application of printed indicia (53), these processes may be carried out in reverse order, depending upon the nature of the embossing and printing methods.

At 56, account identifier 30 is added to stored-value card 10 if account identifier 30 has not otherwise already been added (e.g., printed to, embossed in, adhered to, etc.) or inherently formed as a part thereof prior to or during operations 52, 53, and 54.

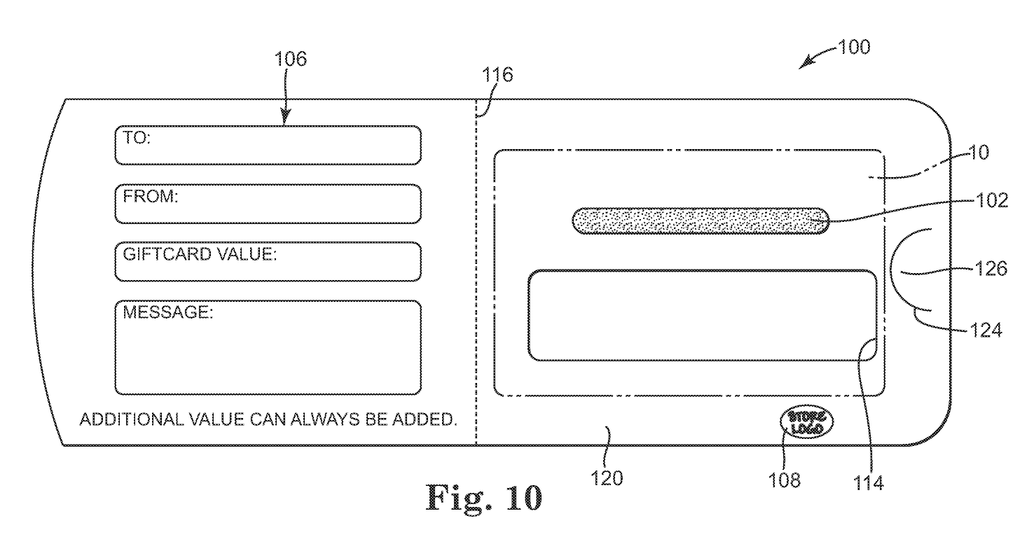

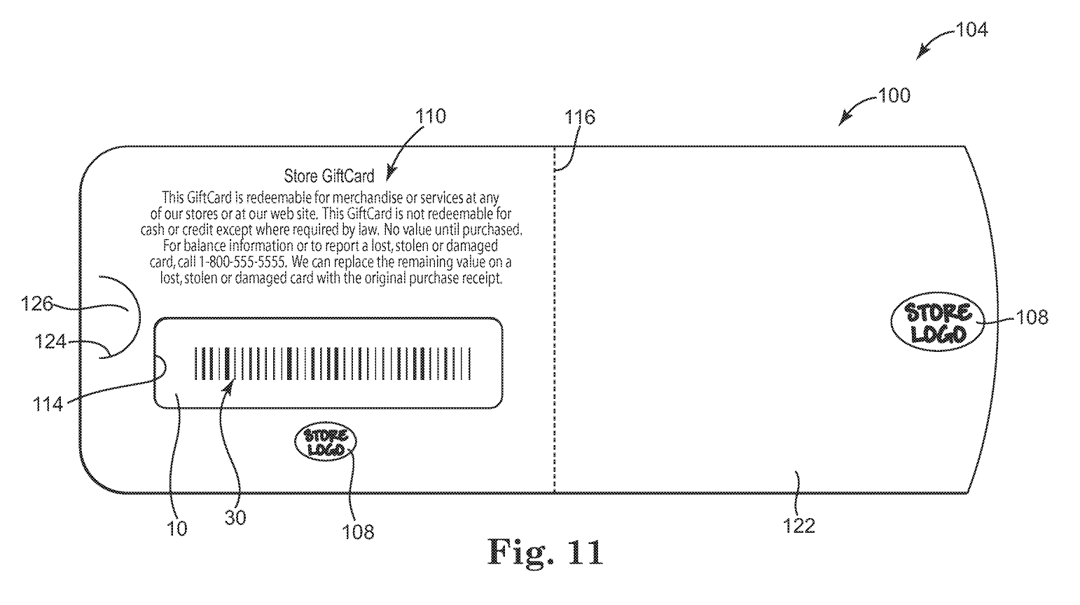

FIGS. 10 and 11 illustrate a carrier or backer 100 configured to be selectively coupled with and to support stored-value card 10. Stored-value card 10, which is represented in phantom lines in FIG. 10 for illustrative purposes so as to not obstruct backer 100, is readily releasably attached to backer 100, for example by a removable adhesive 102, an overlying skinning material, or the like. Backer 100 and stored-value card 10 collectively define a stored-value card assembly 104 (FIG. 11). Backer 100 comprises a single layer or multiple layers of paper or plastic material, for example, generally in the form of a relatively stiff but bendable/flexible card. Use of other materials is also contemplated. Backer 100 displays indicia, graphics or text information including store logo(s), store name(s), slogans, advertising, instructions, directions, brand indicia, promotional information, holiday indicia, seasonal indicia, media format identifiers, characters, and/or other information. For example, indicia, graphics, and/or text information may highlight or otherwise reference the license plate nature of card 10.

In the illustrated embodiment, indicia 106 include to, from, amount, and message fields. The fields of indicia 106 provide areas of backer 100 configured to be written upon by a consumer to personalize backer 100 for presentation as a gift to a particular recipient, for a particular purpose, and/or to indicate a value of stored-value card 10. In one embodiment, stored-value card 10 includes brand indicia 108, which identifies a store, brand, department, etc. and/or services associated with stored-value card 10.

Referring to FIG. 11, in one embodiment, backer 100 includes indicia 110 indicating that stored-value card 10 is redeemable for the purchase of goods and/or services and that upon use, a value of the purchased goods and/or services will be deducted from the financial account or record linked to stored-value card 10. In one embodiment, indicia 110 include phrases such as “<NAME OF STORE> GiftCard” and “This GiftCard is redeemable for merchandise or services at any of our stores or at our web site,” and/or provides help or phone line information in case of a lost, stolen, or damaged stored-value card 10, etc.

Any of indicia 32, 34, 106, 108, 110, identifier 36, or other indicia optionally may appear anywhere on backer 100 or stored-value card 10. Additional information besides that specifically described and illustrated herein may also be included and/or one or more of indicia 32, 34, 106, 108, and 110 or identifier 36 may be eliminated.

In one embodiment, backer 100 includes a window or opening 114 for displaying account identifier 30 of stored-value card 10 therethrough as illustrated in FIG. 11. As previously described, account identifier 30 is adapted for accessing an account or a record associated with stored-value card 10 for activating, loading value to, or debiting value from the account or record. Accordingly, opening 114 allows viewing or other access to account identifier 30 to activate and/or load stored-value card 10 without removing stored-value card 10 from backer 100. In one embodiment, a portion of backer 100 alternatively is configured to be folded away from the remainder of backer 100 to access account identifier 30 without removing stored-value card 10 from backer 100.

In one embodiment, backer 100 is a bi-fold substrate defining a fold line 116, about which backer 100 is foldable roughly in half. In FIGS. 10 and 11, backer 100 is unfolded, i.e., is in an open configuration. According to one embodiment, FIG. 10 illustrates inside surfaces 120 of backer 100 that will be supported on a rack or other fixture to be visible to a consumer of a retail store who is considering the purchase of stored-value card 10. In another example, while on display in a retail store, backer 100 is folded back about fold line 116 to present only portions of inside surfaces 120 of backer 100 (i.e., the surfaces illustrated in FIG. 10) that are positioned on the same side of fold line 116 as stored-value card 10 to a consumer. In such an embodiment, indicia 106 would not be visible to a consumer when backer 100 and stored-value card 10 are placed for display in a retail store. Backer 100 is one example of means for supporting stored-value card 10 for display in a retail setting.

After purchase, backer 100 is foldable about fold line 116 such that inside surfaces 120 (FIG. 10) of backer 100 are folded toward each other and stored-value card 10 is enclosed or wrapped in a compact package formed by foldable backer 100. In this manner, outside surfaces 122 (FIG. 11) of backer 100 are disposed toward the outside of the folded, compact package, according to embodiments of the invention. In one embodiment, folded backer 100 effectively wraps stored-value card 10 for presentation from a consumer to a recipient. Folding backer 100 in the other direction about fold line 116 for display on a rack in a retail setting or about other fold lines of backer 100 is also contemplated. In one embodiment, although described above and depicted in FIGS. 10 and 11 as a single fold line 116, fold line 116 may be one of a plurality of fold lines (not shown) to accommodate various thicknesses of or to otherwise wrap stored-value card 10 as will be apparent to those of skill in the art upon reading this application.

In one embodiment, a cut 124 is formed through backer 100 near an edge of backer 100 that is spaced from and substantially parallel to fold line 116. Cut 124 extends partially toward fold line 116 with an arcuate shape and defines a flap 126, which can be partially bent away from the remainder of backer 100. More specifically, upon folding backer 100 about fold line 116 to close backer 100 around stored-value card 10, an opposing edge of backer 100 is tucked beneath flap 126 to maintain backer 100 in a folded or closed position. In one embodiment, cut 124 and thereby flap 126 are each substantially semi-circular in shape. Other backers similar to backer 100 can be used having various sizes and shapes for supporting stored-value card 10.

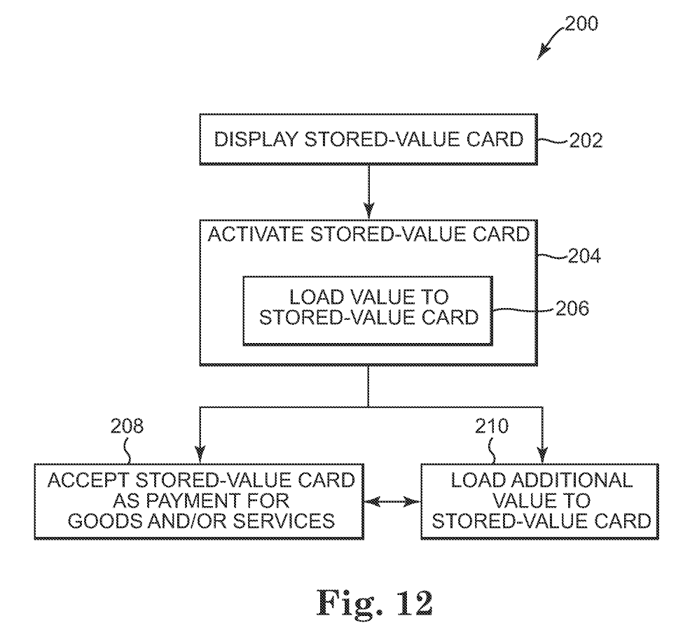

FIG. 12 is a flow chart illustrating one embodiment of a method 200 of encouraging purchase and facilitating use of stored-value card 10 by consumers and/or recipients. At 202, stored-value card 10 is placed on or hung from a rack, shelf, or other similar device to display stored-value card 10 for sale to potential consumers. For example, additionally referring to FIGS. 10 and 11, outside surfaces 122 of backer 100 may be folded about fold line 116 toward one another and stored-value card assembly 104 placed on a display rack such that stored-value card 10 is readily visible to potential consumers. In one embodiment, a depiction of stored-value card 10 is placed on a web site for viewing and purchase by potential consumers.

At 204, a consumer who has decided to purchase stored-value card 10 presents stored-value card 10 on backer 100 to a retail store employee, retail store kiosk, remote terminal, or other person or device to scan account identifier 30 to access an account or record linked to account identifier 30. In particular, account identifier 30 is scanned or otherwise accessed, for example through opening 114 of backer 100 to activate stored-value card 10. Upon accessing the account or record, then, at 206, value is added to the account or record in the form of monetary value, points, minutes, etc. Thus, stored-value card 10 is activated and loaded.

Once stored-value card 10 is activated and loaded, stored-value card 10 can be used by the consumer or any other bearer of stored-value card 10 to purchase goods and/or services at the affiliated retail setting (e.g., a retail store or web site) or can be used in exchange for calling minutes, etc. In one embodiment, where stored-value card 10 is displayed on a web site at 202, then, at 204, stored-value card 10 may be activated in any suitable method and may not require the physical scanning of account identifier 30 to be activated or to otherwise access the associated account or record such as at 206.

In one example, at 208, the retail store or other affiliated retail setting or web site accepts stored-value card 10 as payment toward the purchase of goods and/or services made by the current bearer of stored-value card 10. In particular, the value currently loaded on stored-value card 10 (i.e., stored or recorded in the account or record linked to account identifier 30) is applied toward the purchase of goods and/or services. At 210, additional value is optionally loaded on stored-value card 10 at a point-of-sale terminal, kiosk, or other area of the retail store or related setting. Upon accepting stored-value card 10 as payment at 208, the retail store or related setting can subsequently perform either operation 208 or operation 210 as requested by a current bearer of stored-value card 10. Similarly, upon loading additional value on stored-value card 10 at 210, the retail store or related setting can subsequently perform either operation 210 again or operation 208. In one example, the ability to accept stored-value card 10 as payment for goods and/or services is limited by whether the account or record associated with stored-value card 10 has any value stored or recorded therein at the time of attempted redemption.

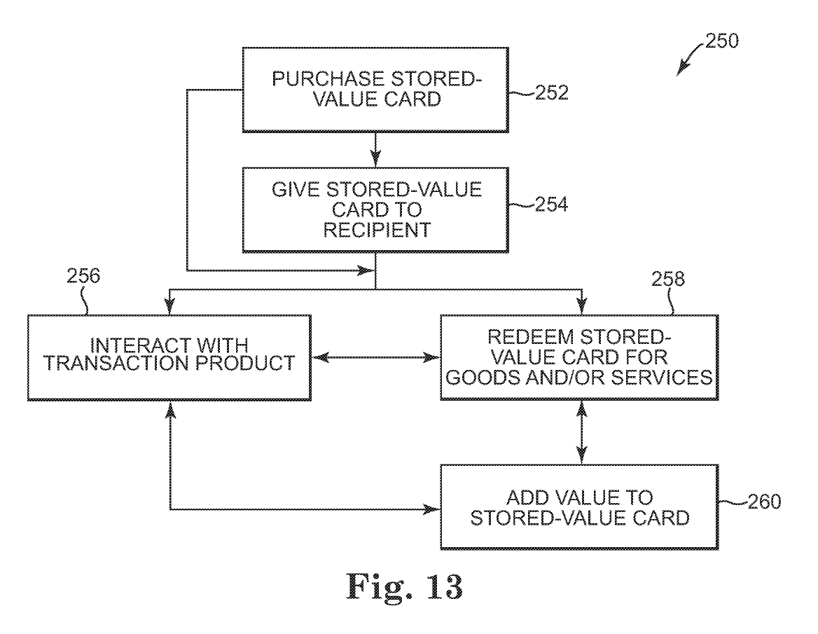

FIG. 13 is a flow chart illustrating one embodiment of a method 250 of using stored-value card 10 (e.g., FIGS. 1-7). At 252, a potential consumer of stored-value card 10, which is displayed in a retail store or viewed on a web site, decides to and does purchase stored-value card 10 from the retail store or web site. It should be understood that stored-value card 10 can be displayed and purchased alone or as part of stored-value card assembly 104 (FIG. 11) along with backer 100. Upon purchasing stored-value card 10, a retail store employee, a retail store kiosk, or other person or device scans account identifier 30 (FIGS. 3 and 11) through opening 114 of backer 100 or otherwise reads or accesses account identifier 30. Upon accessing account identifier 30, the account or record linked to account identifier 30 is accessed and activated to load value onto stored-value card 10 (i.e., load value to the account or record associated with stored-value card 10). In one embodiment, such as where stored-value card 10 is purchased at 252 via a web site, actual scanning or other mechanical detection of account identifier 30 may be eliminated.

At 254, the consumer optionally gives stored-value card 10 to a recipient, such as a graduate, relative, friend, expectant parents, one having a recent or impending birthday, a couple having a recent or impending anniversary, etc. In one embodiment, a plurality of stored-value cards 10 are purchased and given to party goers, such as at a birthday party, etc. as party favors or gifts. As an alternative, the consumer can keep stored-value card 10 for his or her own use thereby eliminating operation 254.

At 256, the consumer, recipient, or other current bearer of stored value card 10 interacts with the card for the purposes of amusement, e.g., by exploring the license plate nature of stored-value card 10 as reflected in embossed indicia 38 and printed indicia 34. For example, the bearer may touch the surfaces 20 and 22 of stored-value card 10 to experience the tactile sensation provided by embossed indicia 38. The current bearer may also utilize holes 42 within substrate 12 to temporarily mount stored-value card 10 on a vehicle, on a display surface, or the like prior to redeeming or adding value at 256 or 258.

At 258, the consumer or recipient redeems stored-value card 10 for goods and/or services from the retail store or web site. At 260, the consumer or recipient of stored-value card 10 optionally adds value to stored-value card 10, more particularly, to the account or record associated with account identifier 30 included therewith, at the retail store or over the Internet (i.e., via the web site). The consumer or recipient of stored-value card 10 subsequently can perform either of operations 256, 258, or 260 as desired. In one embodiment, the ability of the consumer or recipient to repeat redeeming stored-value card 10 at 258 is limited by whether the account or record linked with stored-value card 10 has any remaining value stored or recorded therein at the time of attempted redemption.

Although described above as occurring at a single retail store or web site, in one embodiment, purchasing stored-value card 10 at 252, redeeming stored-value card 10 at 258, and adding value to stored-value card 10 at 260, can each be performed at any one of a number of stores adapted to accept stored-value card 10 or over the Internet. In one example, a number of stores are each part of a chain or are similarly branded stores. In one example, a number of stores include at least one web site and/or at least one conventional brick and mortar store.

Stored-value cards come in many forms, according to embodiments of the invention. The gift card, like other stored-value cards, can be “re-charged” or “re-loaded” at the direction of the original consumer, the gift recipient, or a third party. The term “loading on” or “loaded on” herein should be interpreted to include adding to the balance of an account or record associated with a stored-value card. The balance associated with the stored-value card declines as the card is used, encouraging repeat visits or use. The card remains in the user's purse or wallet, serving as an advertisement or a reminder to revisit the associated merchant. Gift cards according to embodiments of the invention provide a number of advantages to both the consumer and the merchant. Other gift cards and stored-value cards according to embodiments of the invention include loyalty cards, merchandise return cards, electronic gift certificates, calling cards, employee cards, frequency cards, prepaid cards, and other types of cards associated with or representing purchasing power, monetary value, etc.

Although the invention has been described with respect to particular embodiments, such embodiments are meant for illustrative purposes only and should not be considered to limit the invention. Various alternatives and changes will be apparent to those of ordinary skill in the art. Other modifications within the scope of the invention and its various embodiments will be apparent to those of ordinary skill.

What is claimed is:

1. A transaction card comprising:
a substrate defining a first surface and a second surface opposite the first surface;
the substrate including embossed indicia defined by regions projecting in relief with respect to at least one of the first surface and the second surface, wherein the embossed indicia are configured such that the transaction card emulates a license plate; and
the substrate including an account identifier linking the transaction card to at least one of an account and a record, wherein the account identifier is machine readable by a point-of-sale terminal.

2. The transaction card of claim 1, wherein the embossed indicia project in positive relief with respect to the first surface and corresponding negative relief with respect to the second surface.

3. The transaction card of claim 1, wherein:
the first surface has a first area;
the embossed indicia are provided within a second area; and
the second area is greater than approximately 15% of the first area.

4. The transaction card of claim 3, wherein the second area is between approximately 23% and 25% of the first area.

5. The transaction card of claim 1, wherein:
the substrate is rectangular and has a height defined along a minor axis;
the embossed indicia include a plurality of alphanumeric characters having a character height defined along the minor axis; and
wherein the character height is between approximately 30% and 35% of the height.

6. The transaction card of claim 1, wherein the embossed indicia include a plurality of alphanumeric characters having a stroke width greater than approximately 1.0 mm.

7. The transaction card of claim 1, wherein the account identifier is a bar code.

8. The transaction card of claim 1, wherein the account identifier includes at least one of a bar code, a magnetic strip, a smart chip, and a radio frequency identification (RFID) device.

9. The transaction card of claim 1, in combination with a backer selectively coupled with and configured to support the substrate.

10. The transaction card of claim 1, further comprising printed indicia on at least one of the first surface and second surface, wherein the printed indicia are configured such that the transaction card further emulates the license plate.

11. The transaction card of claim 10, wherein a portion of the printed indicia substantially coincides with the embossed indicia.

12. The transaction card of claim 11, wherein the portion of the printed indicia substantially coinciding with the embossed indicia includes a plurality of alphanumeric symbols associated with a celebratory event.

13. The transaction card of claim 12, wherein the plurality of alphanumeric symbols includes a birthday greeting.

14. A method of providing a transaction card, comprising:
forming embossed indicia in a substrate such that the substrate emulates a license plate; and
adding an account identifier to the substrate, wherein the account identifier links the transaction card to an account or record including a value available toward one of the purchase and use of at least one of goods and services.

15. The method of claim 14, wherein forming the embossed indicia includes pressing the substrate between a pair of opposing plates at a temperature of between approximately 65° F. and 75° F.

16. The method of claim 14, wherein the embossed indicia are formed such that the embossed indicia are bounded by a region that is greater than approximately 15% of a total area of the substrate.

17. The method of claim 16, wherein the embossed indicia are bounded by a region that is between approximately 23% and 25% of the total area of the substrate.

18. The method of claim 14, wherein the embossed indicia are formed to include alphanumeric characters having a character height that is between approximately 30% and 35% of a minor axis dimension of the substrate.

19. The method of claim 14, wherein the embossed indicia are formed to have an embossed height that is less than approximately 25% of a thickness of the substrate.

20. The method of claim 14, further including:
forming printed indicia on the substrate such that the printed indicia are further configured to emulate the license plate.

21. A transaction card having a substrate and a plurality of alphanumeric characters formed therein projecting in relief with respect to a surface of the substrate by a distance that is less than approximately a fourth of a thickness of the substrate and having a character height that is greater than approximately a third of an outer dimension of the substrate.

22. The transaction card of claim 21, wherein the substrate is generally rectangular and has an aspect ratio substantially equal to that of a license plate.

23. The transaction card of claim 22, wherein the plurality of alphanumeric characters are generally centered with respect to the substrate.

24. The transaction card of claim 23, wherein the plurality of alphanumeric characters are associated with a birthday greeting.

25. The transaction card of claim 23, further including at least one signature panel generally located adjacent a corner of the substrate.
